(19) United States
(12) Patent Application Publication
(10) Pub. No.: US 2024/0147030 A1
(43) Pub. Date: May 2, 2024

(54) COMPUTER-READABLE RECORDING MEDIUM HAVING STORED THEREIN CONTROL PROGRAM, CONTROL METHOD, AND INFORMATION PROCESSING APPARATUS

(71) Applicant: Fujitsu Limited, Kawasaki-shi (JP)

(72) Inventors: Takashi KATOH, Kawasaki (JP); Kanata SUZUKI, Kawasaki (JP)

(73) Assignee: Fujitsu Limited, Kawasaki-shi (JP)

(21) Appl. No.: 18/364,089

(22) Filed: Aug. 2, 2023

(30) Foreign Application Priority Data
Nov. 2, 2022 (JP) 2022-176313

(51) Int. Cl. H04N 23/11; H04N 5/262; H04N 23/69; H04N 23/80

(52) U.S. Cl. CPC H04N 23/11; H04N 5/2624; H04N 23/69; H04N 23/80; H04N 23/698

(57) ABSTRACT

A control method including: obtaining an image of a given range captured by an image capturing device and a first invisible light image of the range captured by an invisible light image capturing device having a resolution lower than a resolution of the image capturing device; generating a second invisible light image at a resolution higher than a resolution of the first invisible light image by a machine learning model using the image and the first invisible light image as an input; identifying a target area from the range, based on an indicator indicating an uncertainty of each pixel in the second invisible light image; and obtaining, by an optical magnification control of the invisible light image capturing device, a third invisible light image of the target area at a resolution higher than a resolution of the target area in the first invisible light image.

### CROSS-REFERENCE TO RELATED APPLICATION

This application is based upon and claims the benefit of priority of the prior Japanese Patent application No. 2022-176313, filed on Nov. 2, 2022, the entire contents of which are incorporated herein by reference.

### FIELD

The present disclosure relates to a computer-readable recording medium having stored therein a control program, a control method, and an information processing apparatus.

### BACKGROUND

In machine learning, supervised learning using labeled data for training is applied to problems, such as classification of products.

Labeled data is data that is composed of an image obtained by capturing an image capturing range including an object, and a ground truth label imparted to the image indicating the classification (class) of the object. Because ground truth labels are manually imparted to images, collecting labeled data is more costly than collecting unlabeled data.

Another known technique is the panorama composition technique in which multiple magnified images are captured by an inexpensive low-resolution camera and these multiple magnified images are then composited into a high-resolution image.

Related art of this technique is disclosed, for example, in U.S. Patent Application Publication No. 2015/0055886.

As images used for above-described labeled data, higher-resolution images are demanded to be obtained in some cases.

For example, thermal cameras are generally more expensive but have lower resolutions than typical visible light cameras. Therefore, it is conceivable that the panorama composition technique is used to obtain high-resolution thermal images by capturing multiple low-resolution thermal images by a thermal camera, and then compositing these images into a high-resolution thermal image, for example.

### SUMMARY

According to an aspect of the embodiments, a non-transitory computer-readable recording medium having stored therein a control program that causes a computer to execute a process including obtaining a first image of a given image capturing range captured by an image capturing device and a first invisible light image of the image capturing range captured by an invisible light image capturing device having a resolution lower than a resolution of the image capturing device; generating a second invisible light image at a resolution higher than a resolution of the first invisible light image by a machine learning model using the first image and the first invisible light image as an input; identifying an obtaining target area of an invisible light image from the image capturing range, based on an indicator indicating an uncertainty of each of a plurality of pixels included in the second invisible light image; and obtaining, by an optical magnification control of the invisible light image capturing device, a third invisible light image of the obtaining target area at a resolution higher than a resolution of the obtaining target area in the first invisible light image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating resolutions of images;

FIG. 2 is a diagram for schematically depicting a technique according to one embodiment;

FIG. 3 is a diagram illustrating one example of a magnified thermal image;

FIG. 4 is a diagram illustrating an example of a configuration of a system according to one embodiment;

FIG. 5 is a block diagram illustrating a software configuration of a server according to one embodiment;

FIG. 6 is a diagram illustrating one example of a technique to train a model by a training unit;

FIG. 7 is a diagram illustrating one example of a relationship between class probabilities and entropies of pixels;

FIG. 8 is a diagram illustrating one example of an entropy map and magnifying areas;

FIG. 9 is a diagram illustrating one example of a technique to identify a plurality of magnifying areas by a magnifying area identifying unit;

FIG. 10 is a flowchart illustrating an example of an operation of the system according to one embodiment in a training phase;

FIG. 11 is a flowchart illustrating an example of an operation of a process of identifying a magnifying area by the magnifying area identifying unit;

FIG. 12 is a flowchart illustrating an example of an operation of the system according to one embodiment in an inference phase; and

FIG. 13 is a block diagram illustrating an example of a hardware configuration of a computer according to one embodiment.

### DESCRIPTION OF EMBODIMENT(S)

In the panorama composition technique, as the number of images increases, the total time to capture the images lengthens. Therefore, if a target to be captured changes over time, high-resolution thermal images that accurately capture the target may not be obtained due to the lengthened image capturing time. The inability to obtain accurate thermal images at high resolutions may reduce the accuracy of a machine learning model that is to be trained with labeled thermal images as training data.

Note that the above-mentioned problem occurs not only when capturing thermal images by a thermal camera, but may also be experienced when capturing various invisible light images by an invisible light image capturing device.

Hereinafter, an embodiment of the present disclosure will be described with reference to the drawings. Note that the embodiment that will be described is merely exemplary, and it is not intended to exclude various variations and applications of techniques that are not explicitly described below. For example, the present embodiment may be modified in various forms without departing from the scope thereof. In the drawings used in the following description, elements denoted by the like reference symbols denote the same or similar elements unless otherwise stated.

### (A) Description of One Embodiment

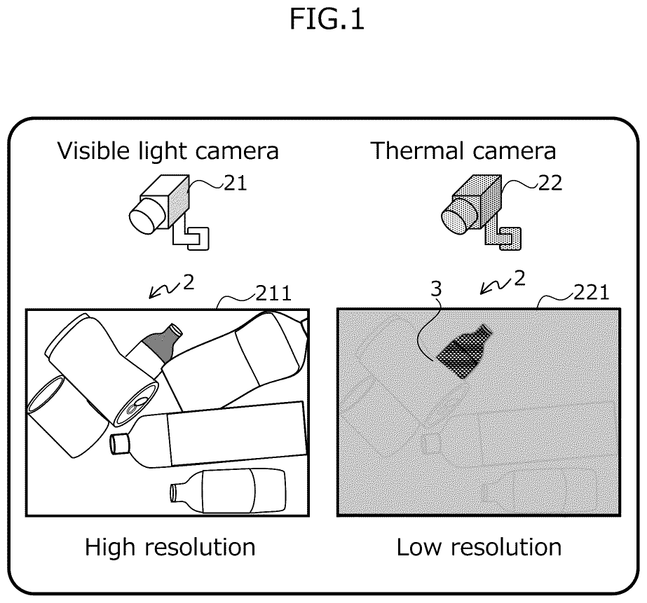

FIG. 1 is a diagram illustrating resolutions of images. In FIG. 1, examples of a visible light image 211 and a thermal image 221 are illustrated.

The visible light image 211 is one example of a first image obtained by capturing a given image capturing range 2 by a visible light camera 21. The visible light camera 21 is one example of an image capturing device (visible light image capturing device).

The thermal image 221 is one example of an invisible light image or first invisible light image obtained by capturing the given image capturing range 2 by a thermal camera 22. The thermal image 221 may also be referred to as an infrared light image. The thermal camera 22 is one example of an invisible light image capturing device, a thermal image capturing device, or an infrared light image capturing device.

In the example in FIG. 1, an object 3 is imaged in the thermal image 221. The temperature of the object 3 is different from the temperatures of other objects because the object 3 has been heated or cooled, for example, and it is imaged (displayed) distinguishable from other objects in the thermal image 221.

In the following, description will be given with reference to an example where invisible light is infrared light (infrared rays), but this is not limiting and various types of light (rays), such as ultraviolet light (ultraviolet rays), may also be used as invisible light.

In the example illustrated in FIG. 1, the resolution of the thermal image 221 is lower than the resolution of the visible light image 211. Here, it is assumed that high-resolution thermal images are demanded to be obtained as labeled data used to train a machine learning model, for example, under these premises.

It is conceivable to use an expensive (high-performance and high-resolution) thermal camera 22 to obtain high-resolution thermal images, but the installation cost and the operation cost would increase.

For example, it is conceivable to capture a plurality of thermal images where parts of an image capturing range are magnified by an inexpensive (low performance and low resolution) thermal camera 22, and to composite these images using the above-described panorama composition technique to obtain a thermal image with a high resolution. The image capturing time, however, would lengthen. If a target to be captured changes over time, accurate high-resolution thermal images may not be obtained and the accuracy of a machine learning model may be reduced due to the lengthened image capturing time.

Here, in one embodiment, a technique to shorten the time to obtain invisible light images (as one example, thermal images) at high resolutions using an inexpensive (low performance and low resolution) invisible light image capturing device will be described.

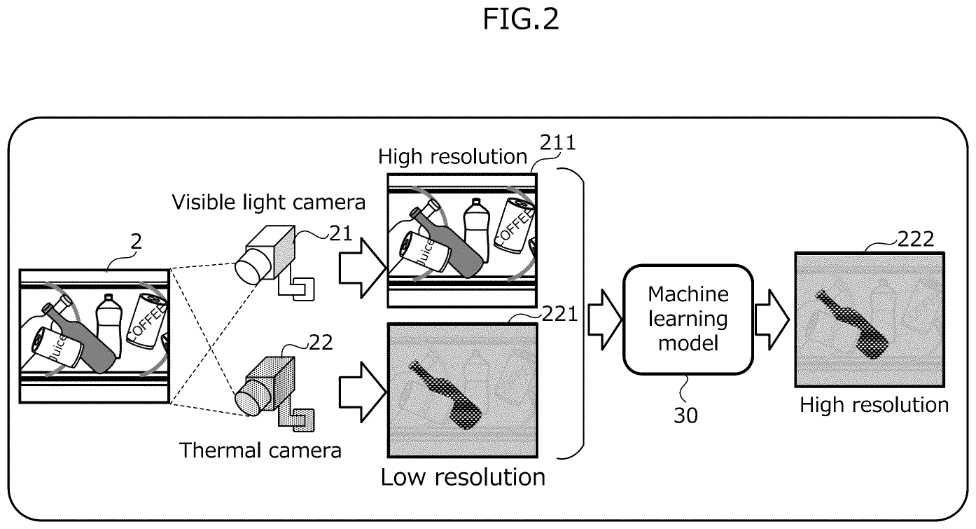

FIG. 2 is a diagram for schematically depicting a technique according to one embodiment. As illustrated in FIG. 2, in one embodiment, a machine learning model 30 is trained to convert the visible light image 211 at a high resolution into a thermal image at a high resolution (sometimes referred to as a “high-resolution thermal image”) 222, so that the high-resolution thermal image 222 can be generated in short time.

The high-resolution thermal image 222 is one example of a second invisible light image at a resolution higher than a resolution of the thermal image 221. The “machine learning model” may also be referred to as “learner” or simply as “model”.

In one embodiment, a low-resolution thermal image 221 is used to supplement the information that is lacking for the conversion from the visible light image 211 to the high-resolution thermal image 222.

In addition, in one embodiment, a magnified thermal image 223 at a low resolution is used to generate supervised data (thermal image at a high resolution) used to train the model 30. The magnified thermal image 223 is one example of a third invisible light image.

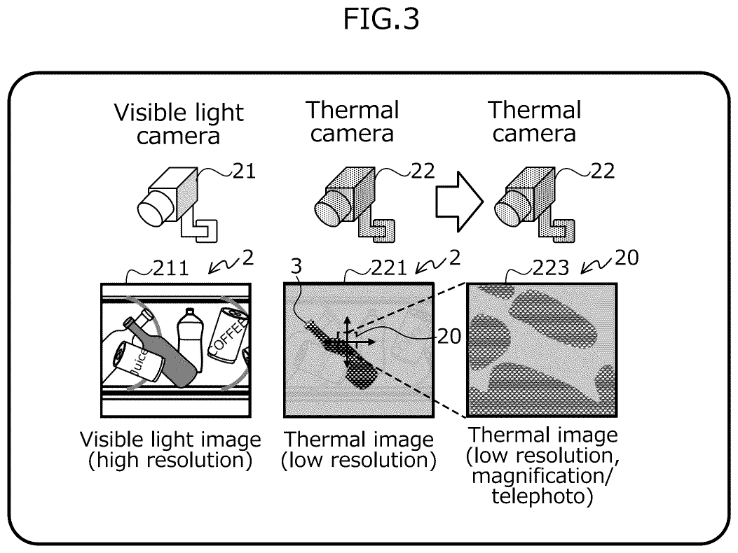

FIG. 3 is a diagram illustrating one example of the magnified thermal image 223. As illustrated in FIG. 3, in one embodiment, the thermal camera 22 captures a thermal image of a magnifying area 20 which is a part of an image capturing range 2 as a magnified thermal image 223 by using the optical zoom (optical magnification) function. The magnifying area 20 is one example of an obtaining target area of the magnified thermal image 223 (thermal image).

Here, the thermal image 221 and the magnified thermal image 223 are identical in image size and the resolution, except for the difference in the ranges to be captured, specifically, the ranges to be captured of the thermal image 221 and the magnified thermal image 223 are the image capturing range 2 and the magnifying area 20, respectively. In other words, as the thermal image 221, the magnified thermal image 223 is an image with a low resolution.

As exemplified in FIG. 2, in the training phase of the model 30, the visible light image 211 and the thermal image 221 are input into the model 30, and the model 30 outputs a thermal image 222 at a resolution higher than a resolution of the thermal image 221.

A magnifying area 20 is then identified from the image capturing range 2 based on an indicator indicating the uncertainty of each of a plurality of pixels included in the high-resolution thermal image 222. In addition, a magnified thermal image 223 is obtained by capturing the magnifying area 20 by the optical magnification control of the thermal camera 22 at a resolution higher than the resolution of the magnifying area 20 included in the thermal image 221.

As described above, according to the technique according to one embodiment, a magnified thermal image 223 used to train the model 30 that is configured to output a high-resolution thermal image 222 can be obtained by using a visible light camera 21 with a high resolution and an inexpensive thermal camera 22 with a low resolution.

The time to obtain a high-resolution thermal image 222 can be shortened by using the model 30 trained with the magnified thermal image 223 even when an inexpensive (low performance and low resolution) thermal camera 22 is used.

In addition, by identifying a magnifying area 20 based on an indicator indicating the uncertainty, training using the magnified thermal image 223 as supervised data can be performed for the portion (pixels) where an output from the model 30 is uncertain, in other words, where the loss is large. Accordingly, efficient training of the model 30 can be achieved.

Note that the thermal camera 22 according to one embodiment may be an image capturing device having an optical zoom function so that a magnified thermal image 223 can be captured. For example, the thermal camera 22 may have a magnification/telephoto function that changes the focal length of the lens of the thermal camera 22 to optically magnify the capturing range from the image capturing range 2 to the magnifying area 20.

Alternatively, in addition to the thermal camera 22, another thermal camera that is disposed closer to the magnifying area 20 than the thermal camera 22 may be provided, and the magnified thermal image 223 may be captured by the other thermal camera. In this case, the optical zoom function may be omitted from the thermal camera 22. The performance and/or the resolution of the other thermal camera may be the same as or different from those of the thermal camera 22.

### (B) Example of Configuration of System According to One Embodiment

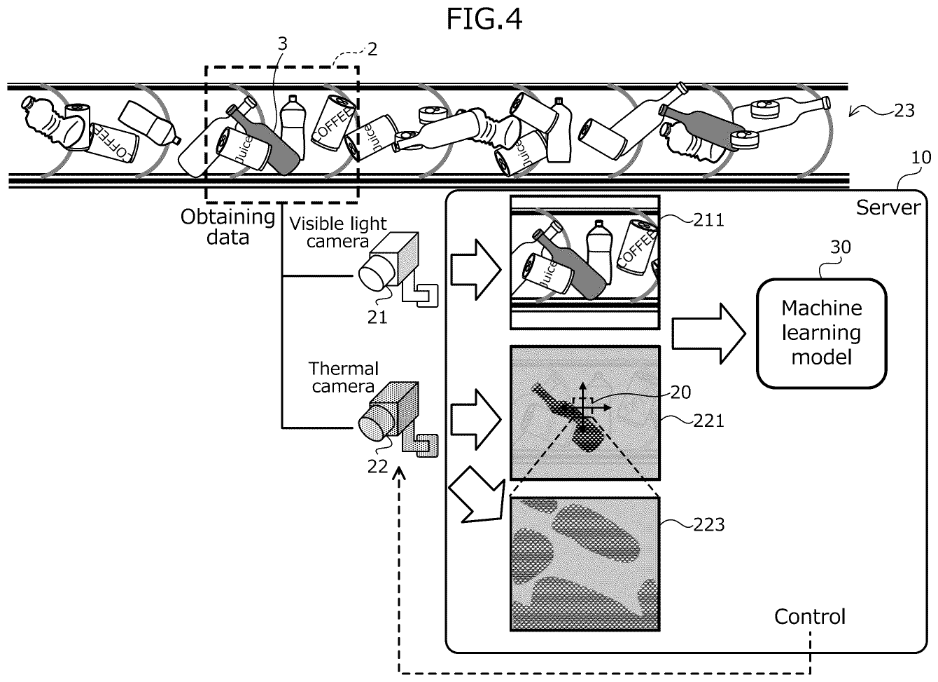

FIG. 4 is a diagram illustrating an example of the configuration of a system 1 according to one embodiment. The system 1 is one example of a machine learning system that performs training of the machine learning model 30. Hereinafter, it is assumed that the machine learning model 30 according to one embodiment converts a visible light image 211 at a high resolution into a thermal image 222 at a high resolution.

In one embodiment, it is assumed that objects 3 present in the image capturing range 2 are recyclable garbage such as bottles, cans, or PET bottles. For example, the high-resolution thermal image 222 output from the model 30 trained by the technique according to one embodiment may be used as training data used to train a machine learning model (not illustrated) to properly separate such recyclable garbage.

As illustrated in FIG. 4, the system 1 may include, as one example, a server 10, a visible light camera 21, a thermal camera 22, and a conveyor belt 23.

The server 10 trains the model 30 and collects training data used for training of the model 30 through a control on at least one of the visible light camera 21 and the thermal camera 22. Details of the process by the server 10 are described later.

The conveyor belt 23 conveys objects 3. The conveyor belt 23 may, for example, convey the objects 3 that are fed in by a robot or an operator (not illustrated). Various conveyors can be used as the conveyor belt 23 such as belt conveyors, chain conveyors, and roller conveyors.

The visible light camera 21 outputs a visible light image 211 obtained by capturing an image capturing range 2 to the server 10. The thermal camera 22 outputs a thermal image 221 obtained by capturing the image capturing range 2 to the server 10. In addition, in response to a control from the server 10, the thermal camera 22 magnifies a part (magnifying area 20) of the field of view (image capturing range 2) by the optical zoom, captures a magnified thermal image 223 of the magnifying area 20, and outputs it to the server 10.

The visible light camera 21 and the thermal camera 22 may be disposed to capture images of the image capturing range 2 at angles similar (preferably identical) to each other. In other words, the visible light camera 21 and the thermal camera 22 may be disposed so that the positional relationships of the objects 3, and the size and position of each objects 3 in the images 211 and 221 are similar (preferably identical) to each other.

In one embodiment, the image capturing range 2 may be a partial area on the conveyor belt 23. Because the positional relationships among the objects 3 remain unchanged depending on the positions on the conveyor belt 23 while objects 3 are conveyed along the conveyor belt 23, the image capturing range 2 of the visible light camera 21 and the image capturing range 2 of the thermal camera 22 may be different from each other. For example, the image capturing range 2 of the visible light camera 21 and the image capturing range 2 of the thermal camera 22 may be spaced apart from each other in the horizontal direction (in parallel) relative to the conveying direction of the conveyor belt 23.

### (C) Example of Software Configuration

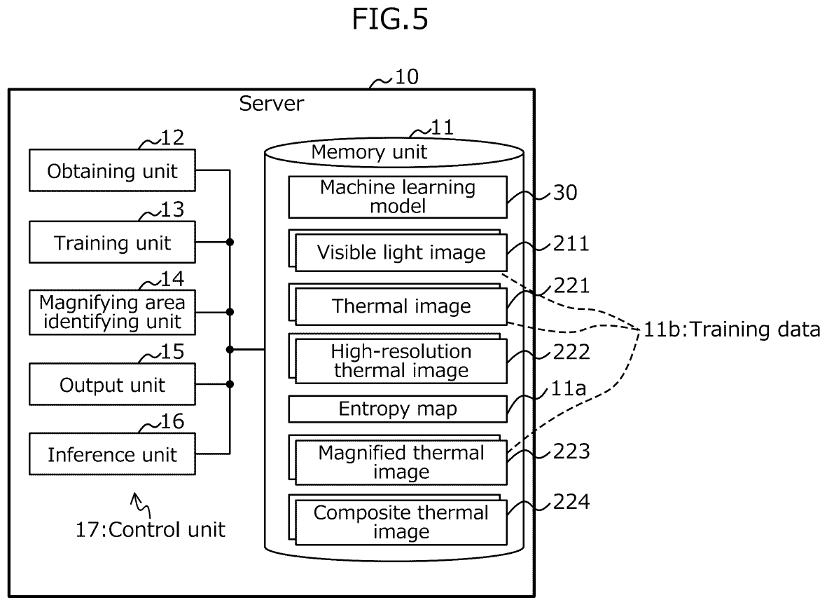

FIG. 5 is a block diagram illustrating an example of the software configuration of the server 10 according to one embodiment. The server 10 is one example of an information processing apparatus or a computer that performs training of the model 30 (and inference using the model 30), and generation and updating of training data.

As illustrated in FIG. 5, the server 10 may include, by way of example, a memory unit 11, an obtaining unit 12, a training unit 13, a magnifying area identifying unit 14, and an output unit 15. The server 10 may also include an inference unit 16. The obtaining unit 12, the training unit 13, the magnifying area identifying unit 14, the output unit 15, and the inference unit 16 are one example of a control unit 17.

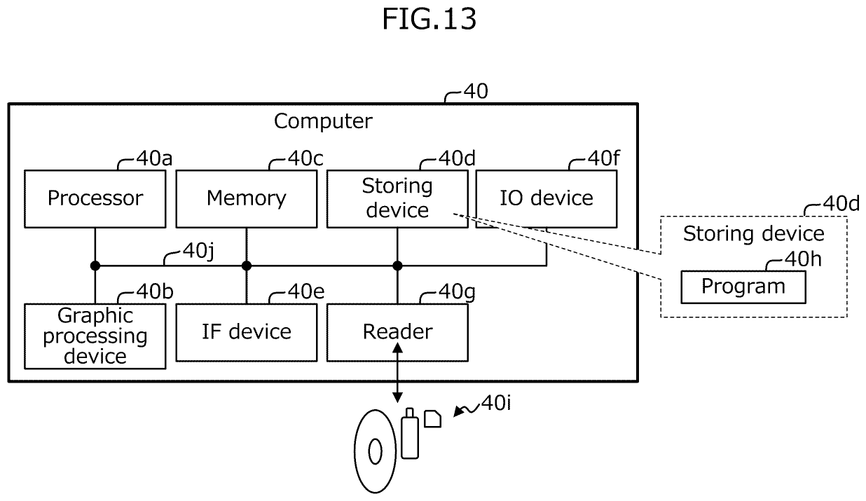

The memory unit 11 is one example of a storage area and stores various types of data used by the server 10. The memory unit 11 may be implemented, for example, by a storage area possessed by at least one of a memory 40c and a storing device 40d (see FIG. 13) to be described later in the server 10.

As illustrated in FIG. 5, the memory unit 11 may be capable of storing, by way of example, a machine learning model 30, a plurality of visible light images 211, a plurality of thermal images 221, a plurality of high-resolution thermal images 222, a plurality of magnified thermal images 223, a plurality of composite thermal images 224, and an entropy map 11a.

Hereinafter, various pieces of information stored in the memory unit 11 are described in table formats for the sake of convenience. This is not limiting, however, and at least one piece of information stored in the memory unit 11 may be in any of various formats, such as a database (DB) or arrays.

The obtaining unit 12 obtains various types of information used by the server 10. For example, the obtaining unit 12 may obtain a plurality of visible light images 211 from the visible light camera 21 and a plurality of thermal images 221 and a plurality of magnified thermal images 223 from the thermal camera 22, and store them in the memory unit 11.

In the training phase, the training unit 13 performs training (retraining, machine learning process) of the machine learning model 30 using training data 11b which contains a plurality of data sets including the visible light images 211, the thermal images 221, and the magnified thermal images 223. For example, the training unit 13 inputs the visible light images 211 and the thermal images 221 to the model 30, and performs supervised or semi-supervised learning using the magnified thermal images 223 as supervised data.

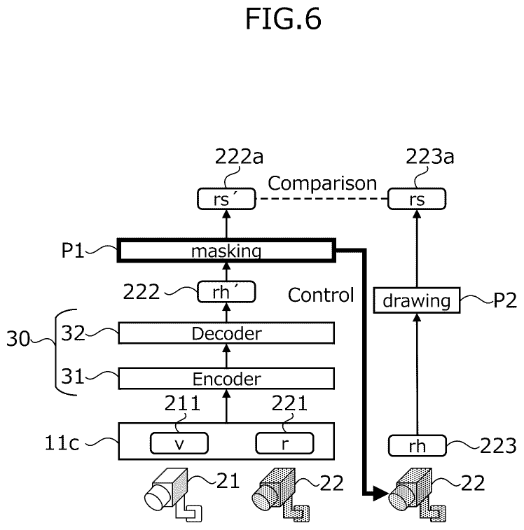

FIG. 6 is a diagram illustrating one example of a technique to train the model 30 by the training unit 13. As illustrated in FIG. 6, the model 30 may include, for example, an encoder 31 and a decoder 32.

As exemplified in FIG. 6, the training unit 13 inputs a visible light image (denoted as “v” in FIG. 6) 211 and a thermal image (denoted as “r” in FIG. 6) 221 to the encoder 31, and obtains a high-resolution thermal image (denoted as “rh′” in FIG. 6) 222 from the decoder 32. In addition, the decoder 32 outputs class probabilities for each pixel included in the high-resolution thermal image 222, each class corresponding to the output range in accordance with the resolution (resolving power) of the thermal camera 22.

The training unit 13 masks a magnifying area 20 present in the high-resolution thermal image 222 by a masking process P1 (denoted as “masking” in FIG. 6), and outputs an image of the masked section in the high-resolution thermal image 222 as a partial image (denoted as “rs′” in FIG. 6) 222a. The partial image 222a may be an image generated by cropping only the magnifying area 20 in the high-resolution thermal image 222, or may be an image where the region outside the magnifying area 20 in the high-resolution thermal image 222 is processed so as to be excluded from comparison (e.g., the region outside the magnifying area 20 is filled with a single color). The magnifying area 20 is identified in a magnifying area identifying process by the magnifying area identifying unit 14.

The thermal camera 22 captures a magnified thermal image (denoted as “rh” in FIG. 6) 223 of the magnifying area 20. The training unit 13 may generate, for example, a comparative magnified thermal image (denoted as “rs” in FIG. 6) 223a by a drawing process P2 (denoted as “drawing” in FIG. 6) based on the magnified thermal image 223.

The comparative magnified thermal image 223a is used for comparing the magnified thermal image 223 against the partial image 222a. In the drawing process P2, a processing for making the magnified thermal image 223 comparable against the partial image 222a may be executed. As one example, the training unit 13 may change or modify the format, an attribute, or the like of the image in the drawing process P2.

As another example, in the case where the partial image 222a is a high-resolution thermal image 222 where the range outside the magnifying area 20 is excluded from comparison, the training unit 13 may generate a comparative magnified thermal image 223a by placing the magnified thermal image 223 at the position of the magnifying area 20 in the image capturing range 2. For example, the training unit 13 may generate a comparative magnified thermal image 223a by specifying an off-target area to be excluded from comparison around the magnified thermal image 223. The off-target area may be an area that is processed in the manner similar to the processing on the partial image 222a, such as filling with a single color, for example.

As another example, in the case where the partial image 222a includes a plurality of magnifying areas 20 and a plurality of magnified thermal images 223 have been captured, the training unit 13 may generate a comparative magnified thermal image 223a by compositing the plurality of magnified thermal images 223 in the drawing process P2.

The training unit 13 may perform training of the model 30 by comparing the partial image 222a against the comparative magnified thermal image 223a and updating (optimizing) a parameter of a neural network of the model 30 (the encoder 31 and the decoder 32) based on the result of the comparison. For example, the training unit 13 may update the parameter so that the difference between the partial image 222a and the comparative magnified thermal image 223a is minimized. For updating the parameter, various optimization algorithms, such as the gradient descent, may be used, for example.

When a plurality of magnifying areas 20 different from each other are identified in one high-resolution thermal image 222, the training unit 13 may generate one partial image 222a in which each of the plurality of magnifying areas 20 is imaged in a single image of the image capturing range 2. In this case, the training unit 13 may generate one comparative magnified thermal image 223a in which each of a plurality of magnified thermal images 223 obtained by capturing the plurality of magnifying areas 20 by the thermal camera 22 is imaged in a single image of the image capturing range 2. Alternatively, the training unit 13 may generate a partial image 222a and a comparative magnified thermal image 223a for each magnified thermal image 223 that has been captured.

Note that the training unit 13 may store the partial image 222a and the comparative magnified thermal image 223a in a storage area such as the memory unit 11.

The magnifying area identifying unit 14 identifies one or more magnifying areas 20 by executing a magnifying area identifying process on the high-resolution thermal image 222. For example, the magnifying area identifying unit 14 may identify, as the magnifying area 20, a part of the high-resolution thermal image 222 where an output from the model 30 is uncertain.

Here, as described above, the model 30 outputs class probabilities for each pixel included in the high-resolution thermal image 222.

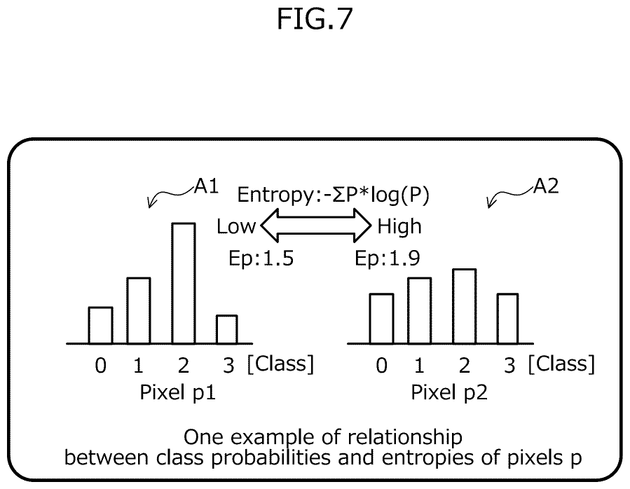

FIG. 7 is a diagram illustrating one example of the relationship between class probabilities and entropies of pixels p. In the example in FIG. 7, the probability that a value of a pixel p in the high-resolution thermal image 222 is in a given class is represented by the height of a bar of that class in a bar graph, for each class of the output range (four levels in the example in FIG. 7) in accordance with the resolution (resolving power) of the thermal camera 22.

As exemplified in FIG. 7, Class 2 has the highest class probability of the pixel p1 indicated by the reference symbol A1, which is twice or more the class probabilities of Classes 0, 1, and 3. On the other hand, the class probabilities of Classes 0, 1, 2, and 3 of the pixel p2 indicated by the reference symbol A2 are all almost the same. In the example in FIG. 7, the certainty that the value of the pixel p1 is Class 2 is high, whereas the certainty that the value of the pixel p2 is Class 2 is low.

In the example in FIG. 7, for a class size of 4, the possible values of entropy, when the unit is in bits (with a base of 2 for the logarithm), ranges from 0 to 2. For example, in cases where the class probabilities are almost the same, as in the case of the pixel p2, the entropy approaches 2 (1.9 in the example in FIG. 7), which is higher than the entropy of the pixel p1 (1.5 in the example in FIG. 7).

As described above, an area where the output from the model 30 is uncertain can be identified from the distribution of class probabilities. Thus, the magnifying area identifying unit 14 calculates an indicator (uncertainty indicator) indicating the uncertainty of each pixel from the class probabilities that are output from the model 30.

An example of this indicator (score) is, for example, the entropy which decreases as the class certainty increases and increases as the class certainty decreases. In the example in FIG. 7, the entropy (Ep) of the pixel p1 is 1.5 and is relatively low, whereas the entropy (Ep) of the pixel p2 is 1.9 and is relatively high. Pixels in the high-resolution thermal image 222 having high entropies are a part where the output from the model 30 is uncertain, or in other words, a part having a large loss.

Note that the actual loss cannot be calculated at the stage of identification of the magnifying areas 20 because a magnified thermal image 223 serving as supervised data has not been generated yet. However, the loss assuming that a magnified thermal image 223 can be obtained can be estimated.

For example, the magnifying area identifying unit 14 may assume the output from the model 30 as the probability of obtaining each class, to thereby estimate the entropy of the output from the model 30 as the expected value of the loss (expected loss).

Alternatively, the magnifying area identifying unit 14 may estimate the loss when the class having the maximum value (Class 2 in the example in FIG. 7) is the actual class (the correct class) in the output from the model 30, as the minimum loss.

In one embodiment, a case in which the magnifying area identifying unit 14 calculates an entropy as the expected loss will be described. For example, because data having a larger loss has a greater impact on the training of the model 30, the magnifying area identifying unit 14 identifies an area having high entropies (having a large expected loss) in the high-resolution thermal image 222 as the magnifying area 20 so that the model 30 is efficiently trained.

The magnifying area identifying unit 14 may generate, for example, an entropy map 11a in which the entropies of a plurality of pixels are arranged according to the arrangement of the pixels in the high-resolution thermal image 222, and may identify a magnifying area 20 based on the entropy map 11a.

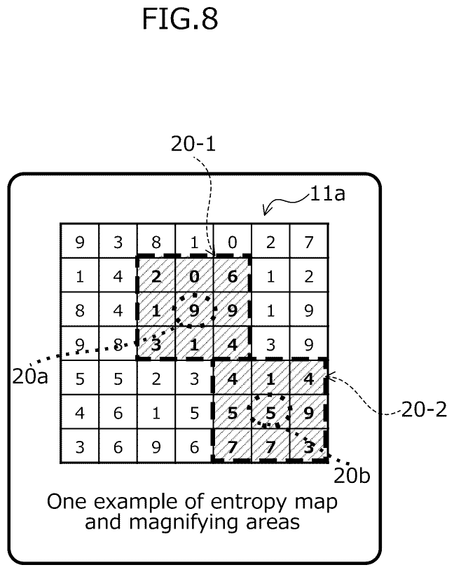

FIG. 8 is a diagram illustrating one example of an entropy map 11a and magnifying areas 20. In the example in FIG. 8, each rectangle labeled with an entropy value corresponds to one pixel.

For example, the magnifying area identifying unit 14 may identify, as a magnifying area 20, an area having the largest sum of entropies of pixels within the magnifying area 20, of a plurality of entropies. As one example, the magnifying area identifying unit 14 may identify one or more magnifying areas 20 that can be captured by the thermal camera 22 within a given time period, based on a given cost related to the optical zoom control of the thermal camera 22 and the sum of entropies.

The given cost may be, for example, the time to be consumed to control the optical zoom of the thermal camera 22 (magnified image capturing time). The magnified image capturing time may include, for example, the mechanical drive time, such as time to be consumed for changing the focal length and changing the angle of the thermal camera 22, and the image capturing time for the thermal camera 22 to capture the magnifying area 20.

The given time period may be, for example, the allowable time to capture magnified thermal images 223 for one high-resolution thermal image 222. The given cost (default cost), the given time period (default time period), or both may be determined in advance by, for example, an administrator or the like.

For example, based on the entropy map 11a, the magnifying area identifying unit 14 may identify a magnifying range having the largest sum of entropies, from the magnifying ranges (combinations of pixels) that can be captured within a given time period under the constraint of a given cost. The magnifying area identifying unit 14 may also calculate a migration path from the current image capturing target position of the thermal camera 22 to the identified magnifying range.

The image capturing target position is, for example, the reference point for the image capture angle or the orientation of the thermal camera 22, and may be, as one example, the position of a pixel that coincides with the center of an image to be captured by the thermal camera 22.

As exemplified in FIG. 8, a magnifying range that can be captured by the thermal camera 22, i.e., a range captured by optical zoom, is a range of a combination of hatched pixels enclosed by the dashed line (3×3 square in the example in FIG. 8). The magnifying area identifying unit 14 may identify a magnifying range having the largest sum of entropies of the pixels within the magnifying range, as a magnifying area 20. In the example in FIG. 8, a magnifying area 20-1 centered around the pixel at the image capturing target position 20a indicated by the dotted line is identified.

In addition, when two or more magnified thermal images 223 can be captured within the given time period under the constraint of the given cost, the magnifying area identifying unit 14 may identify other magnifying areas 20 within the range where the optical zoom can be controlled from the image capturing target position 20a within the given time period. FIG. 8 illustrates an example in which a magnifying area 20-2 centered around the pixel at the image capturing target position 20b indicated by the dotted line is identified.

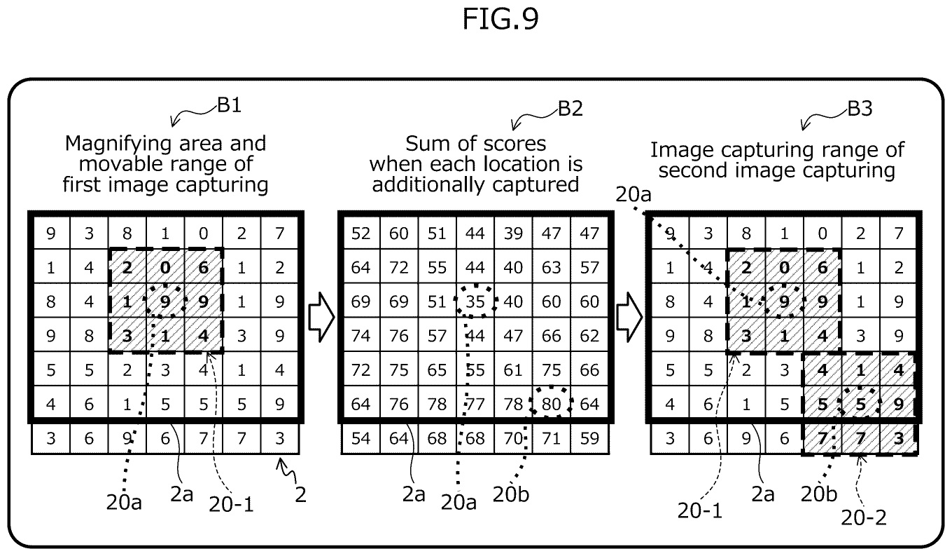

FIG. 9 is a diagram illustrating one example of a technique to identify a plurality of magnifying areas 20 by the magnifying area identifying unit 14. The reference symbol B1 in FIG. 9 indicates a magnifying area 20-1 identified for the first time and a movable range 2a movable from the magnifying area 20-1 within the given time period. If the image capturing target position 20a is the initial position of the thermal camera 22, the magnifying area identifying unit 14 may omit processes of the reference symbols B2 and B3 described below and identify the magnifying range centered around the initial position as the first magnifying area 20-1.

As indicated by the reference symbol B2 in FIG. 9, the magnifying area identifying unit 14 may calculate the sum of entropy (score) of each pixel included in the movable range 2a in the case where an additional magnified thermal image 223 centered around each pixel is to be captured. For example, for each cell (pixel) within the movable range 2a, the magnifying area identifying unit 14 may calculate the sum of entropies within the magnifying range centered around the cell, as the sum of scores for that cell.

As exemplified by the reference symbol B3 in FIG. 9, the magnifying area identifying unit 14 may identify the pixel having the largest calculated sum (80 in the example of the reference symbol B2 in FIG. 9) as the image capturing target position 20b, and identify the magnifying area 20-2 centered around the image capturing target position 20b.

The magnifying area identifying unit 14 may control the thermal camera 22 by using the information on the identified image capturing target positions 20a and 20b as the start point and the end point of the movement path for capturing magnified thermal images 223 by the thermal camera 22.

Once the magnifying area identifying unit 14 identifies one or more magnifying areas 20, it may control the thermal camera 22 to capture the identified magnifying areas 20 according to the identified movement path. Magnified thermal images 223 captured by the thermal camera 22 may be output to the training unit 13 via the obtaining unit 12. In addition, the magnifying area identifying unit 14 may notify the training unit 13 of the identified magnifying areas 20 so that the magnifying areas 20 are used in the masking process P1.

When the third and subsequent magnified thermal images 223 are to be captured for one high-resolution thermal image 222, the magnifying area identifying unit 14 may identify a movable range starting from the image capturing target position 20b in FIG. 9. Then, the magnifying area identifying unit 14 may identify a magnifying area 20 and the movement path within the movable range by the technique exemplified with the reference symbols B2 and B3 in FIG. 9 described above.

When a second or subsequent magnified thermal image 223 is to be captured for one high-resolution thermal image 222, and when an object 3 moves in the image capturing range 2, for example, the magnifying area identifying unit 14 may identify a magnifying area 20 based on the moving speed of the object 3 and a given cost. For example, the magnifying area identifying unit 14 may identify a magnifying area 20 by shifting each entropy in the entropy map 11a in the direction of the movement of the object 3 in the high-resolution thermal image 222.

As described above, according to the training unit 13 and the magnifying area identifying unit 14, a magnifying area 20 is identified from the image capturing range 2 based on an indicator indicating the uncertainty of each of the plurality of pixels included in the high-resolution thermal image 222, each of the plurality of pixels having a corresponding indicator. Then, a magnified thermal image 223 of the magnifying area 20 captured by the optical zoom control of the thermal camera 22 is obtained at a resolution higher than the resolution of the magnifying area 20 in the thermal image 221.

Hence, because a magnified thermal image 223 of the magnifying area 20 based on an indicator indicating the uncertainty, e.g., the magnifying area 20 having the maximum loss, can be obtained, supervised data effective for training of the model 30 that is configured to output a high-resolution thermal image 222 can be obtained. Therefore, the obtainment time of a high-resolution thermal image 222 can be shortened by using the model 30 trained with a magnified thermal image 223 even when an inexpensive (low performance and low resolution) thermal camera 22 is used.

Of the overall process time of the process by the training unit 13 and the magnifying area identifying unit 14 described above, the magnified image capturing time by the thermal camera 22 is dominant. Therefore, as the number of captured magnified thermal image 223 is increased, the likelihood of obtaining supervised data effective for training of the model 30 is increased but the time to obtain a high-resolution thermal image 222 can also increase.

According to the technique according to one embodiment, a magnifying range having larger indicators indicating the uncertainties is preferentially selected as the magnifying area 20 within the movable range 2a. Accordingly, even if the number of captured magnified thermal image 223 is small, supervised data effective for training of the model 30 can be efficiently collected. Therefore, according to the technique according to one embodiment, it is possible to obtain an optimal high-resolution thermal image 222 and to shorten the obtainment time within various constraints such as the time available for capturing images, the performance of the thermal camera 22 (resolution, magnified image capturing time), and the like.

The output unit 15 outputs output data. The output data includes, for example, at least one type of data of the model 30, the visible light images 211, the thermal images 221, the high-resolution thermal images 222, the magnified thermal images 223, composite thermal images 224 (described below), the entropy map 11a, and the like. The output data may also include an inference result obtained by inputting input data (e.g., visible light images different from the visible light images 211 and thermal images 221 used in the training phase) into the trained model 30 during the inference phase.

In the “output” of the output data, the output unit 15 may, for example, transmit (provide) the output data to another computer (not illustrated), or store the output data in the memory unit 11 and manage the data in such a manner that it can be obtained from the server 10 or another computer. Alternatively, in the “output” of the output data, the output unit 15 may output information indicating the output data on a screen of an output device of the server 10, an administrator terminal, or the like, or may output the output data in any of various other ways. The administrator terminal is one example of a computer used by the administrator or the user of the server 10.

In the inference phase, the inference unit 16 performs the inference process using the model 30 that has been trained by the training unit 13. For example, the inference unit 16 may input visible light images and thermal images (not illustrated) which are data to be subjected to the inference process into the model 30, and store a high-resolution thermal image 222 which is the inference result output from the model 30, into the memory unit 11.

Also in the inference phase, the training unit 13 and the magnifying area identifying unit 14 may generate a magnified thermal image 223 (or a comparative magnified thermal image 223a) based on the high-resolution thermal image 222 output from the model 30.

The inference unit 16 may generate a composite thermal image 224 by replacing a partial image 222a of a magnifying area 20 included in the high-resolution thermal image 222 with the magnified thermal image 223 (or the comparative magnified thermal image 223a), and may store the composite thermal image 224 in the memory unit 11. The composite thermal image 224 is one example of a fourth invisible light image.

As described above, by using the composite thermal image 224 instead of the high-resolution thermal image 222 as the inference result, at least part of an image obtained by inference by the model 30 can be supplemented with the magnified thermal image 223 that is actually captured at a higher resolution. Accordingly, supervised data with a quality (accuracy) higher than a quality of supervised data obtained when only the high-resolution thermal image 222 is used as the inference result can be generated.

In the above process, the model 30 that is configured to output high-resolution thermal images 222 is updated in the server 10 by machine learning using training data 11b including visible light images 211, thermal images 221, and magnified thermal images 223 in the training phase. Then, in the inference phase, visible light images and thermal images are input to the trained model 30, and a high-resolution thermal image 222 or a composite thermal image 224 is output from the model 30 as the inference result.

Thus, in cases where thermal images are used as labeled data, for example, labeled data with thermal images at low resolutions can be upsampled to labeled data with thermal images at high resolutions using an inexpensive thermal camera 22. Accordingly, the labeled data can be used to train a machine learning model that performs artificial intelligence (AI) tasks, such as classification, object detection, and segmentation, to thereby improve the accuracy of AI tasks at a low cost, for example.

### (D) Example of Operation

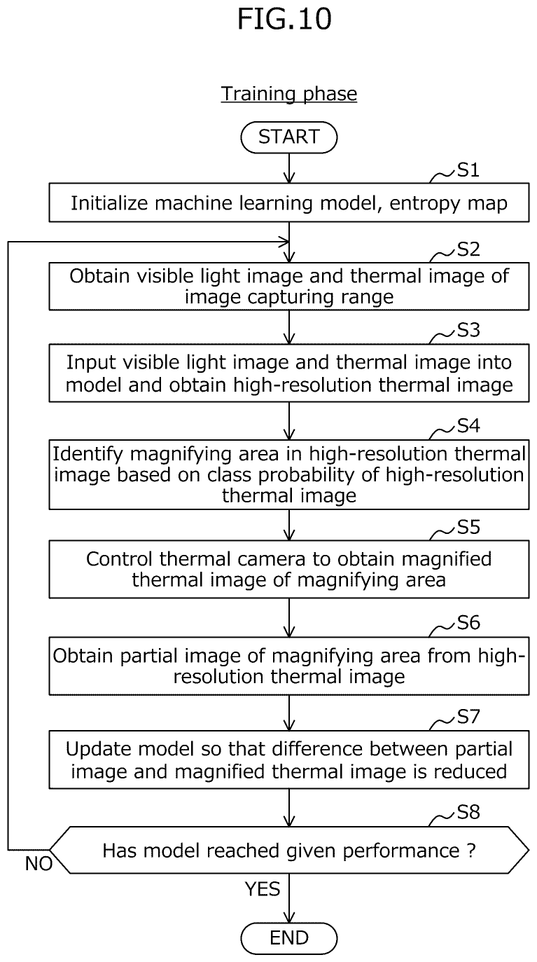

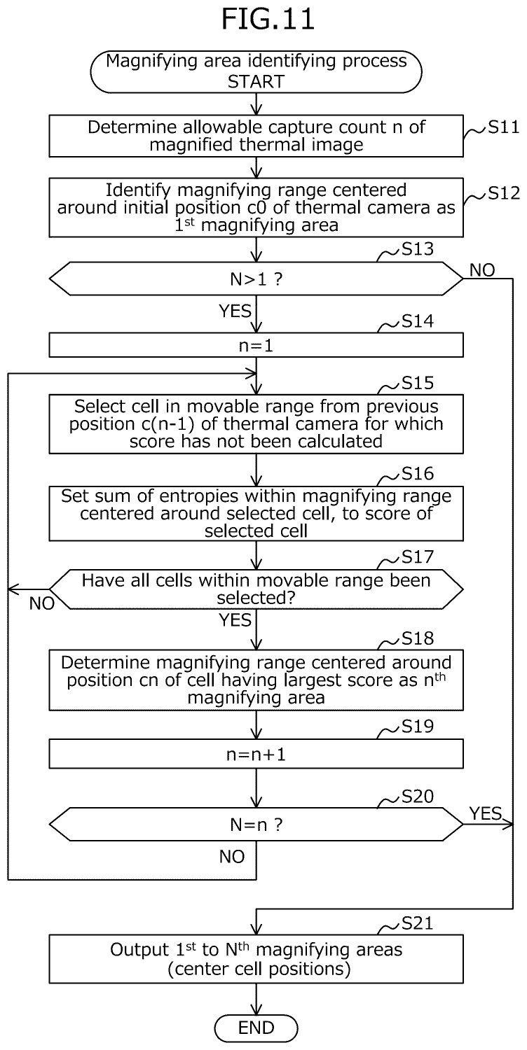

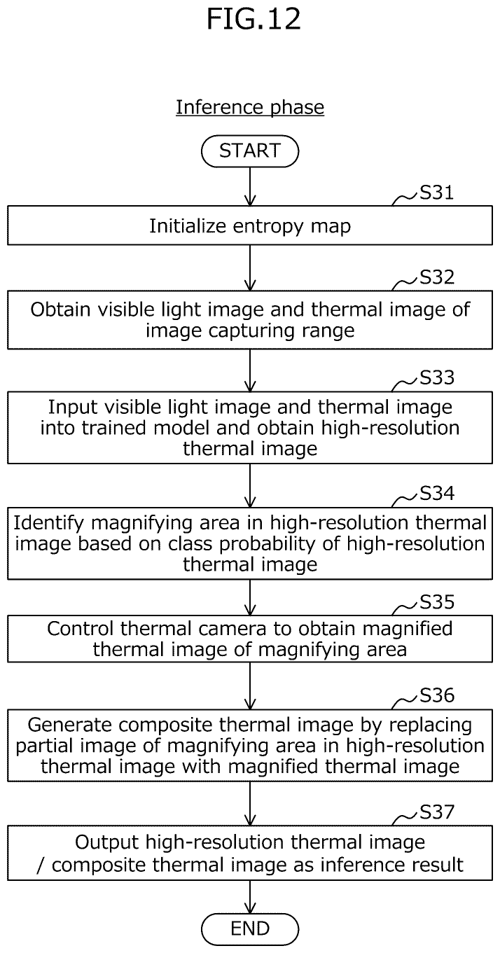

Next, examples of operations of the system 1 according to one embodiment will be described. FIG. 10 is a flowchart illustrating an example of an operation of the system 1 according to one embodiment in the training phase. FIG. 11 is a flowchart illustrating an example of an operation of the process of identifying a magnifying area 20 by the magnifying area identifying unit 14. FIG. 12 is flowchart illustrating an example of an operation of the system 1 according to one embodiment in the inference phase.

(D-1) Example of Operation in Training Phase

As exemplified in FIG. 10, in the training phase, the training unit 13 initializes the model 30. The magnifying area identifying unit 14 also initializes the entropy map 11a (Step S1).

The training unit 13 obtains a visible light image 211 of an image capturing range 2 captured by the visible light camera 21 and a thermal image 221 of the image capturing range 2 captured by the thermal camera 22 (Step S2).

The training unit 13 inputs the visible light image 211 and the thermal image 221 to the model 30, and obtains a high-resolution thermal image 222 (Step S3).

The magnifying area identifying unit 14 updates the entropy map 11a based on the class probabilities of the high-resolution thermal image 222 and identifies a magnifying area 20 in the high-resolution thermal image 222 (Step S4).

The magnifying area identifying unit 14 controls the thermal camera 22, and obtains a magnified thermal image 223 of the magnifying area 20 captured by the thermal camera 22 (Step S5).

The training unit 13 obtains a partial image 222a of the magnifying area 20 from the high-resolution thermal image 222 (Step S6). Note that the processes in Steps S5 and S6 may be performed in reverse order or may be performed at least partially in parallel.

The training unit 13 updates the model 30 so that the difference between the partial image 222a and the magnified thermal image 223 (or comparative magnified thermal image 223a) is reduced (Step S7).

The training unit 13 determines whether or not the model 30 has reached a given performance (Step S8). If it is determined that model 30 has not reached the given performance (NO in Step S8), the process transitions to Step S2 and the training phase is executed again.

If it is determined that the model 30 has reached the given performance (YES in Step S8), the process ends.

Next, an example of the operation of the process of identifying the magnifying area 20 by the magnifying area identifying unit 14 in Step S4 in FIG. 10 will be described.

As exemplified in FIG. 11, the magnifying area identifying unit 14 identifies the allowable capture count N that is allowable to capture magnified thermal images 223 within a given time period (Step S11). As one example, the allowable capture count N may be calculated as the maximum N satisfying the following expression (1). In the following expression (1), α is a constant of 0 or more. The magnified image capturing time is the time to be consumed to capture an image of a magnifying area 20 by the thermal camera 22 (e.g., mechanical drive time and the image capturing time).

N≤(given time period−α)/magnified image capturing time (1)

The magnifying area identifying unit 14 identifies the magnifying range centered around the initial position c0 (e.g., image capturing target position 20a in FIG. 9) of the thermal camera 22 as the first magnifying area 20 (Step S12).

The magnifying area identifying unit 14 determines whether or not N is greater than 1 (Step S13). If it is determined that N is equal to or smaller than 1 (practically, N=1) (NO in Step S13), the process transitions to Step S21.

If it is determined that N is greater than 1 (YES in Step S13), the magnifying area identifying unit 14 sets 1 to the variable n (Step S14).

The magnifying area identifying unit 14 looks up the entropy map 11a and selects one cell (pixel) of which the score has not been calculated, within the movable range 2a from the previous position c(n−1) of the thermal camera 22 (Step S15).

The magnifying area identifying unit 14 sets the sum of entropies within the magnifying range centered around the selected cell, to the score of the selected cell (Step S16).

The magnifying area identifying unit 14 determines whether or not all cells within the movable range 2a have been selected (Step S17). If it is determined that there is any unselected cell (NO in Step S17), the process transitions to Step S15.

If it is determined that all cells within the movable range 2a have been selected (YES in Step S17), the magnifying area identifying unit 14 identifies the magnifying range centered around the position cn of the cell having the largest calculated score as the n^{th} magnifying area 20 (Step S18).

The magnifying area identifying unit 14 increments n (Step S19), and determines whether or not N=n (Step S20). If it is determined that N≠n (NO in Step S20), the process transitions to Step S15.

If it is determined that N=n (YES in Step S20), the magnifying area identifying unit 14 outputs information on the first to N^{th} magnifying areas 20 (e.g., information indicating the positions of the cells c0 to c (n−1)) (Step S21), and the process ends. The information on the first to N^{th} magnifying areas 20 may be used to generate the movement path for controlling the thermal camera 22 by the magnifying area identifying unit 14 (Step S5 in FIG. 10) and to generate a partial image 222a by the training unit 13 (Step S6 in FIG. 10).

Note that the server 10 may determine an image capturing plan (movement path) of a plurality of magnifying areas 20 first, and then capture a plurality of magnified thermal images 223 in accordance with the image capturing plan for one or more high-resolution thermal images 222, for example.

(D-2) Example of Operation in Inference Phase

As exemplified in FIG. 12, in the inference phase, the magnifying area identifying unit 14 initializes the entropy map 11a (Step S31).

The inference unit 16 obtains, as data to be inferred, a visible light image of the image capturing range 2 captured by the visible light camera 21 and a thermal image of the image capturing range 2 captured by the thermal camera 22 (Step S32).

The inference unit 16 inputs the visible light image and the thermal image to the trained model 30, and obtains a high-resolution thermal image 222 (Step S33).

The magnifying area identifying unit 14 updates the entropy map 11a based on the class probabilities of the high-resolution thermal image 222 and identifies a magnifying area 20 in the high-resolution thermal image 222 (Step S34). The process of Step S34 may be executed by the process exemplified in FIG. 11.

The magnifying area identifying unit 14 controls the thermal camera 22, and obtains a magnified thermal image 223 of the magnifying area 20 captured by the thermal camera 22 (Step S35).

The inference unit 16 generates a composite thermal image 224 by replacing the partial image 222a of the magnifying area 20 in the high-resolution thermal image 222 with the magnified thermal image 223 (Step S36).

The inference unit 16 outputs at least one of the high-resolution thermal image 222 and the composite thermal image 224 as the inference result (Step S37), and the process ends. Note that the processes of Steps S31 and S34 to S36 may be omitted (skipped).

### (E) Example of Hardware Configuration

The server 10 according to one embodiment may be a virtual server (VM; Virtual Machine) or a physical server. In addition, the functions of the server 10 may be implemented by a single computer or by two or more computers.

Hereinafter, the hardware (HW) configuration of a computer 40 that implements the functions of the server 10 will be described.

FIG. 13 is a block diagram illustrating an example of the hardware configuration of the computer 40 according to one embodiment. When a plurality of computers are used as HW resources for embodying the functions of the server 10, each computer may have the HW configuration illustrated in FIG. 13.

As illustrated in FIG. 13, the computer 40 may include, by way of example, a processor 40a, a graphic processing device 40b, a memory 40c, a storing device 40d, an interface (IF) device 40e, an input/output (I/O) device 40f, and a reader 40g as the HW configuration.

The processor 40a is one example of a processing unit configured to perform a wide variety of controls and computations. The processor 40a may be communicatively connected to each other to each block in the computer 40 via a bus 40j. Note that the processor 40a may be a multiprocessor including multiple processors or a multi-core processor including multiple processor cores, or may have a configuration having multiple multi-core processors.

Examples of the processor 40a include an integrated circuit (IC), such as a CPU, an MPU, an APU, a DSP, an ASIC, and an FPGA, for example. Note that a combination of two or more of these integrated circuits may be used as the processor 40a. CPU is an abbreviation for Central Processing Unit, and MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The graphic processing device 40b controls a screen display for an output device, such as a monitor of the IO device 40f. The graphic processing device 40b may also be configured as an accelerator to execute the machine learning process and the inference process using the machine learning model 30. Examples of the graphic processing device 40b include various arithmetic processing units, for example, an integrated circuit (IC) such as a graphic processing unit (GPU), an APU, a DSP, an ASIC, or an FPGA.

The training unit 13 exemplified in FIG. 5 may cause the graphic processing device 40b to execute the machine learning process by the model 30 using a visible light image 211 and a thermal image 221 as input data and a magnified thermal image 223 as supervised data, and may obtain a high-resolution thermal image 222 from the model 30. In addition, the inference unit 16 may cause the graphic processing device 40b to execute the inference process by the model 30 using a visible light image and a thermal image for inference as input data, and may obtain an inference result from the model 30.

The memory 40c is one example of HW configured to store information, such as a wide variety of data and programs. The memory 40c may include a volatile memory such as a dynamic random access memory (DRAM), a non-volatile memory such as a persistent memory (PM), or both, for example.

The storing device 10d is one example of HW configured to store information, such as a wide variety of data and programs. Examples of the storing device 40d include a wide variety of storage apparatuses, such as a magnetic disk apparatus, e.g., a hard disk drive (HDD), a semiconductor drive apparatus, e.g., a solid state drive (SSD), and a non-volatile memory. Examples of the nonvolatile memory include a flash memory, a storage class memory (SCM), and a read only memory (ROM).

Storage areas in at least one of the memory 40c and the storing device 40d may be used as the storage area, e.g., the memory unit 11 illustrated in FIG. 5, used by the server 10 for storing various types of data.

The storing device 40d may store a program 40h (control program) for embodying all or a part of various functions of the computer 40.

For example, in the computer 40 of the server 10, the processor 40a can embody the functions as the control unit 17 (e.g., the blocks 12 to 16) illustrated in FIG. 5, by expanding the program 40h stored in the storing device 40d on the memory 40c and executing the program 40h expanded on the memory 40c.

The IF device 40e is one example of a communication IF configured to carry out processing, such as controls on connections and communications between the computer 40 and other computers. For example, the IF device 40e may include an adapter compliant with a local area network (LAN) such as Ethernet®, optical communications such as Fibre Channel (FC), or the like. The adapter may support at least one of wireless and wired communication technologies.

For example, the server 10 may communicate data (transmit output data to an administrator terminal or the like as one example) via the IF device 40e and a network (not illustrated). In addition, the server 10 may obtain images from the visible light camera 21 and the thermal camera 22, and perform controls on the visible light camera 21 and the thermal camera 22 (including controls on the optical magnification of the thermal camera 22), and the like, via the IF device 40e and a network (not illustrated). Note that the program 40h may be downloaded from a network to the computer 40 via that communication IF and stored in the storing device 40d.

The IO device 40f may include an input device, an output device, or both. Examples of the input device include, a keyboard, a mouse, and a touch panel, for example. Examples of the output device include a monitor, a projector, and a printer, for example. Alternatively, the IO device 40f may include a touch panel or other device that integrates the input device and the output device. The output device may be connected to the graphic processing device 40b.

The reader 40g is one example of a reader that reads data and information of a program recorded on a recording medium 40i. The reader 40g may include a connection terminal or device to which the recording medium 40i can be connected or inserted. Examples of the reader 40g include an adapter compliant with the Universal Serial Bus (USB) or any of other standards, a drive device for accessing a recording disk, and a card reader for accessing a flash memory, such as an SD card, for example. Note that the recording medium 40i may store the program 40h, and the reader 40g may read the program 40h from the recording medium 40i and store it in the storing device 40d.

Examples of the recording medium 40i may include, as an example, non-transitory computer-readable recording media, such as magnetic/optical disks and flash memories. Examples of the magnetic/optical disks may include, as an example, flexible disks, compact discs (CDs), digital versatile discs (DVDs), Blu-ray discs, and holographic versatile discs (HVDs). Examples of the flash memories may include semiconductor memories, such as USB memories and SD cards, for example.

The HW configuration of the computer 40 described above is merely exemplary. Accordingly, in the computer 40, HW may be added or omitted (e.g., any blocks may be added or omitted), divided, or merged in any combinations, or a bus may be added or omitted, where it is deemed appropriate.

### (F) Miscellaneous

The above-describe technique according to the aforementioned embodiment may be practiced in the following modifications or variations.

For example, the obtaining unit 12, the training unit 13, the magnifying area identifying unit 14, the output unit 15, and the inference unit 16 provided in the server 10 as illustrated in FIG. 5 may be merged or divided.

In addition, for example, the server 10 illustrated in FIG. 5 may have a configuration where a plurality of apparatuses cooperate with each other via a network to embody each process function. As one example, the obtaining unit 12 and the output unit 15 may be a web server and an application server, the training unit 13, the magnifying area identifying unit 14, and inference unit 16 may be an application server, and the memory unit 11 may be a DB server, etc. In this case, the web server, the application servers, and the DB server may cooperate with each other via a network to embody each process function as the server 10.

In addition, although description has been made with reference to the example where the thermal camera 22 is used as an invisible light image capturing device in one embodiment, for example, this is not limiting. X-ray image capturing devices, ultrasound image capturing devices, and the likes that employ image capturing techniques different from that of visible light cameras can be used as the invisible light image capturing devices. In addition, for example, various types of image capturing devices which capture images and output a given captured image in the manner that objects 3 that have undergone a certain treatment are distinguishable from other objects may be used as the invisible light image capturing device. In this case, a visible light image 211 and an image captured by the image capturing device may be used as an input to train the model 30 so that a higher resolution version of the image captured by the image capturing device is output.

The certain treatment may be, for example, a treatment that imparts a physical or chemical change to an object 3 while maintaining the shape of the object 3 or minimizing changes of the shape. Examples of such a treatment include, for example, application (e.g., coating) of a given liquid or powder to the surface of the object 3, and irradiation of ultraviolet or other light rays on the object 3.

The given captured image may be, for example, an image that visualizes the physical or chemical change imparted to the object 3 by the certain treatment. For example, the given captured image may be an image imaging the given liquid or powder applied to the surface of the object 3, or the change of the surface of the object 3 caused by irradiation of light, or the like in the manner that object 3 is distinguishable from other objects. The image capturing device may be, for example, an image capturing device that can detect such physical or chemical change.

In one aspect, the present disclosure can shorten the obtainment time of high-resolution invisible light images.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a control program that causes a computer to execute a process comprising:
obtaining a first image of a given image capturing range captured by an image capturing device and a first invisible light image of the image capturing range captured by an invisible light image capturing device having a resolution lower than a resolution of the image capturing device;
generating a second invisible light image at a resolution higher than a resolution of the first invisible light image by a machine learning model using the first image and the first invisible light image as an input;
identifying an obtaining target area of an invisible light image from the image capturing range, based on an indicator indicating an uncertainty of each of a plurality of pixels included in the second invisible light image; and
obtaining, by an optical magnification control of the invisible light image capturing device, a third invisible light image of the obtaining target area at a resolution higher than a resolution of the obtaining target area in the first invisible light image.

2. The non-transitory computer-readable recording medium according to claim 1, wherein
the identifying the obtaining target area comprises identifying, as the obtaining target area, an area having a largest sum of values of indicators of pixels within the obtaining target area, of a plurality of the indicators, each of the plurality of pixels having a corresponding indicator.

3. The non-transitory computer-readable recording medium according to claim 2, wherein
the identifying the obtaining target area comprises identifying one or more obtaining target areas that can be captured by the invisible light image capturing device within a given time period based on a given cost related to the optical magnification control of the invisible light image capturing device and the sum of the values of the indicators.

4. The non-transitory computer-readable recording medium according to claim 1, the process further comprising
training the machine learning model so that a difference between a partial image of the obtaining target area included in the second invisible light image and the third invisible light image is minimized.

5. The non-transitory computer-readable recording medium according to claim 1, the process further comprising
outputting a fourth invisible light image generated by replacing a partial image of the obtaining target area included in the second invisible light image with the third invisible light image, as an inference result of the machine learning model.

6. The non-transitory computer-readable recording medium according to claim 1, wherein
the image capturing device is a visible light image capturing device that captures a visible light image, and
the invisible light image capturing device is an infrared light image capturing device that captures an infrared light image.

7. A control method executed by a computer, the control method comprising:
obtaining a first image of a given image capturing range captured by an image capturing device and a first invisible light image of the image capturing range captured by an invisible light image capturing device having a resolution lower than a resolution of the image capturing device;
generating a second invisible light image at a resolution higher than a resolution of the first invisible light image by a machine learning model using the first image and the first invisible light image as an input;
identifying an obtaining target area of an invisible light image from the image capturing range, based on an indicator indicating an uncertainty of each of a plurality of pixels included in the second invisible light image; and
obtaining, by an optical magnification control of the invisible light image capturing device, a third invisible light image of the obtaining target area at a resolution higher than a resolution of the obtaining target area in the first invisible light image.

8. The control method according to claim 7, wherein
the identifying the obtaining target area comprises identifying, as the obtaining target area, an area having a largest sum of values of indicators of pixels within the obtaining target area, of a plurality of the indicators, each of the plurality of pixels having a corresponding indicator.

9. The control method according to claim 8, wherein
the identifying the obtaining target area comprises identifying one or more obtaining target areas that can be captured by the invisible light image capturing device within a given time period based on a given cost related to the optical magnification control of the invisible light image capturing device and the sum of the values of the indicators.

10. The control method according to claim 7, further comprising
training the machine learning model so that a difference between a partial image of the obtaining target area included in the second invisible light image and the third invisible light image is minimized.

11. The control method according to claim 7, further comprising
outputting a fourth invisible light image generated by replacing a partial image of the obtaining target area included in the second invisible light image with the third invisible light image, as an inference result of the machine learning model.

12. The control method according to claim 7, wherein
the image capturing device is a visible light image capturing device that captures a visible light image, and
the invisible light image capturing device is an infrared light image capturing device that captures an infrared light image.

13. An information processing apparatus comprising:
a memory; and
a processor coupled to the memory, the processor being configured to:
obtain a first image of a given image capturing range captured by an image capturing device and a first invisible light image of the image capturing range captured by an invisible light image capturing device having a resolution lower than a resolution of the image capturing device;
generate a second invisible light image at a resolution higher than a resolution of the first invisible light image by a machine learning model using the first image and the first invisible light image as an input;
identify an obtaining target area of an invisible light image from the image capturing range, based on an indicator indicating an uncertainty of each of a plurality of pixels included in the second invisible light image; and
obtain, by an optical magnification control of the invisible light image capturing device, a third invisible light image of the obtaining target area at a resolution higher than a resolution of the obtaining target area in the first invisible light image.

14. The information processing apparatus according to claim 13, wherein
in the identifying of the obtaining target area, the processor is configured to identify, as the obtaining target area, an area having a largest sum of values of indicators of pixels within the obtaining target area, of a plurality of the indicators, each of the plurality of pixels having a corresponding indicator.

15. The information processing apparatus according to claim 14, wherein
in the identifying of the obtaining target area, the processor is configured to identify one or more obtaining target areas that can be captured by the invisible light image capturing device within a given time period based on a given cost related to the optical magnification control of the invisible light image capturing device and the sum of the values of the indicators.

16. The information processing apparatus according to claim 13, wherein
the processor is configured to train the machine learning model so that a difference between a partial image of the obtaining target area included in the second invisible light image and the third invisible light image is minimized.

17. The information processing apparatus according to claim 13, wherein
the processor is configured to output a fourth invisible light image generated by replacing a partial image of the obtaining target area included in the second invisible light image with the third invisible light image, as an inference result of the machine learning model.

18. The information processing apparatus according to claim 13, wherein
the image capturing device is a visible light image capturing device that captures a visible light image, and
the invisible light image capturing device is an infrared light image capturing device that captures an infrared light image.
